(19) United States
(12) Patent Application Publication
(10) Pub. No.: US 2008/0220398 A1
(43) Pub. Date: Sep. 11, 2008

(54) Anticipaintings

(76) Inventor: Kathryn Lillian Dendooven, Milwaukee, WI (US)

Correspondence Address: VONBRIESEN & ROPER, S.C., 411 EAST WISCONSIN AVENUE, SUITE 700, MILWAUKEE, WI, 53202, US

(21) Appl. No.: 11/682,071

(22) Filed: Mar. 5, 2007

(51) Int. Cl. G09B 11/10

(52) U.S. Cl. 434/84

(57) ABSTRACT

The present invention generally relates to a kit and a method for capturing life prints. More particularly, the present invention uses a painted body part to create a body print, whereby at least one shape is positioned around at least one contour of the body print to create a recognizable design.

### FIELD OF INVENTION

The present invention generally relates to a kit and a method for creating art prints. More particularly, the present invention uses a painted body part to create a body print, whereby at least one shape is positioned around at least one contour of the body print to create a recognizable design.

### BACKGROUND OF THE INVENTION

Today, people search for ways to create artwork to celebrate and immortalize various physiological stages of human development. An infant's first pair of shoes is often bronzed to display and capture the size of the infant's feet during various stages of early development. To more realistically capture stages of human development, people have plaster casts made of their body parts during various stages of development. The most common body parts cast are hands, feet, and posterior.

In an attempt to capture a stage of development prior to birth, pregnant mothers cast their pregnant bellies. Depending on the body part, casts may be cumbersome, and difficult to display. Casts may also appear to be cold and lifeless. Accordingly, the present invention facilitates the creation of easily displayed artwork that immortalizes physiological stages of human development.

### SUMMARY OF THE INVENTION

The present invention generally relates to a kit and a method for capturing life prints. More particularly, the present invention uses a painted body part to create a body print, whereby at least one shape is positioned around at least one contour of the body print to create a recognizable design.

The kit comprises: a print-receiving surface; at least one shape, wherein at least one edge of the shape is approximately congruent to a contour of a body print; at least one paint; and at least one application device.

The method for capturing a life print comprises: creating a body print by applying a painted body part to a surface; using a blueprint to position at least one shape to have at least one edge approximately congruent to a contour of the body print; tracing the shape; and painting any area inside the traced shape to create a recognizable design.

To create artwork using the present invention, several body parts may be used to create a body print. The body parts may include, but are not limited to hands, feet, posterior, and/or a woman's pregnant belly.

To provide a foundation for the artwork, a print-receiving surface is used. The print-receiving surface may be a canvas, and the size and color of the canvas may vary. Canvas colors may include, but are not limited to yellow, green, blue, and any pastel colors generally found in a baby's nursery.

To provide a visual sense to the artwork, paint is applied to a print-receiving surface by an application device and a body part. Paint colors may vary, and they may include, but are not limited to blue, light-blue, grey, white, brown, light-brown, cream, black, orange, yellow, green, light-green, red, light-red, purple, light-purple, and pastel colors generally found in a baby's nursery.

To convert a body print into a work of art, at least one shape is positioned in conjunction with the contours of the body print and traced to produce a recognizable design. At least one shape has at least one edge configured to match the, generally round, contour of the body print. Recognizable designs are practically unlimited, and they may include, but are not limited to an airplane, a bear, a flower, a goldfish, a frog, a car, a sheep, a crab, and an octopus.

Other objects and details of the present invention will become apparent from the following detailed description.

### BRIEF DESCRIPTION OF THE DRAWING

The present invention will be better understood by reference to the accompanying drawings, wherein:

FIG. 1 is an illustration of a body part being painted by an application device;

FIG. 2 is an illustration of a painted body part being pressed against a print-receiving surface to create a body print;

FIG. 3 is an illustration of a template being cut to create shapes;

FIG. 4 is an illustration of a blueprint used to indicate how to position at least one shape in conjunction with the contours of a body print;

FIG. 5 is an illustration of shapes being traced while at least one shape is positioned in conjunction with the contours of a body print;

FIG. 6 is an illustration of traced shapes creating a recognizable design;

FIG. 7 is an illustration of how an application device is used to paint any remaining area inside a traced shape;

FIG. 8 is an illustration of a final artwork.

### DETAILED DESCRIPTION OF THE INVENTION

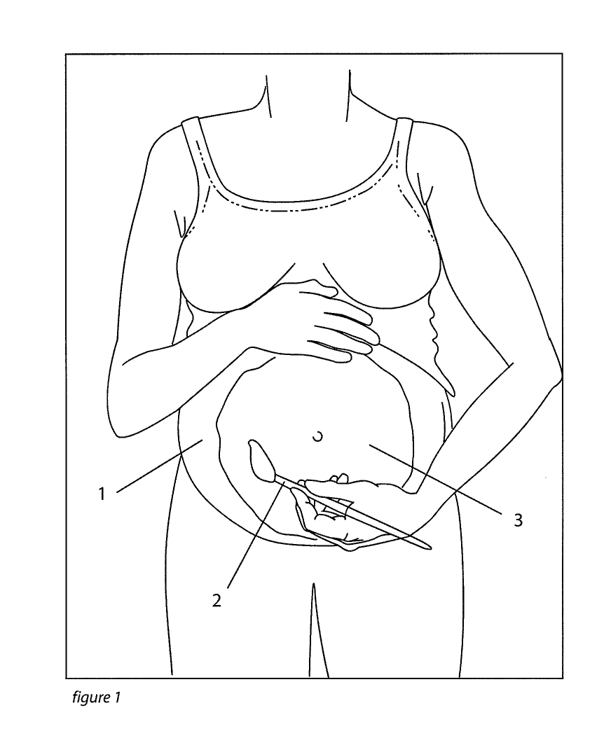

FIGS. 1-8 helps illustrate a detailed description and the preferred embodiment of the present invention.

To create artwork using the present invention, several body parts may be used to create the body print, including but not limited to hands, feet, posterior and/or a woman's pregnant belly.

FIG. 1 generally illustrates a woman's pregnant belly (1) being painted by an application device (2). The preferred application device (2) is a size 8 long handled flat brush, but other application devices may also be used, including but not limited to various sized brushes, sponges, tissues, and cotton swabs. Using an application device (2), paint (3) should be liberally applied to sufficiently cover the surface of the woman's pregnant belly (1). The preferred paint (3) is lukascryl studio acrylic, but other paints and inks may also be used.

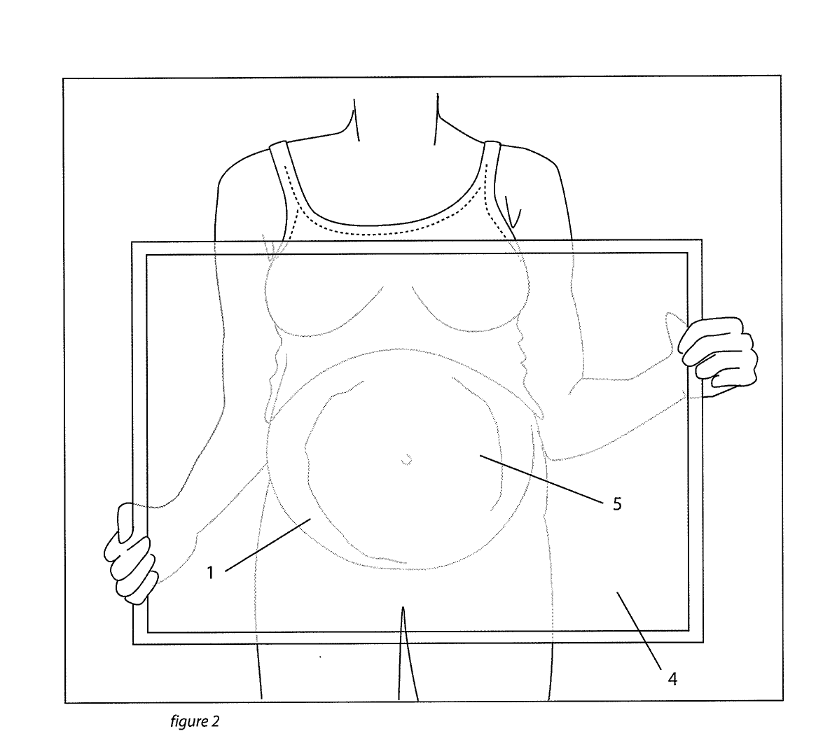

FIG. 2 generally illustrates a woman's painted pregnant belly (1) being pressed against a print-receiving surface (4) to create a body print (5). The preferred print-receiving surface (4) is pre-stretched canvas that is made with Tuck-N-Roll construction. The size of the canvas may vary, but preferably the canvas should have four flat edges to make the artwork aesthetic for frameless presentation. The user should firmly press the body part (1) against the print-receiving surface (4) to create a uniform body print (5). Canvas colors may vary, but preferably the canvas color should be a paler color than any paints applied directly to the canvas.

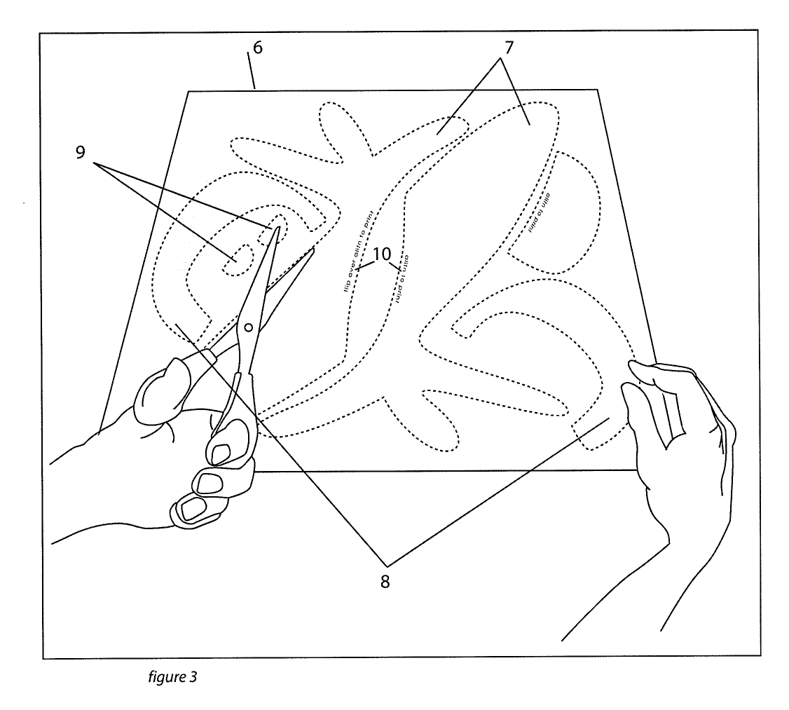

FIG. 3 generally illustrates a frog template (6) being cut to create recognizable body shapes. Dashed lines are shown inside the four corners of the template (6). The dashed lines represent an outline of a frog's various anatomical parts. The user should cut along the dashed lines of the frog template (6) with a cutting device. Preferably, the cutting device is scissors but other cutting devices may also be used, including but not limited to a utility knife. The shapes, from the frog template (6), create a frog print by using the body print of a woman's pregnant belly as the frog's body. The shapes include legs (7), eye sockets (8) and eyes (9) (collectively, “body shapes (7)(8)(9)”). The interior edge (10) of the frog leg shape (7) is rounded to match the contours of the body print of a woman's pregnant belly. For clarification, contour is defined as a shape or outline of something.

In another embodiment, the kit will include a frog template (6) that is already pre-cut. The user will not be required to cut the body shapes (7) (8) (9) from the frog template (6).

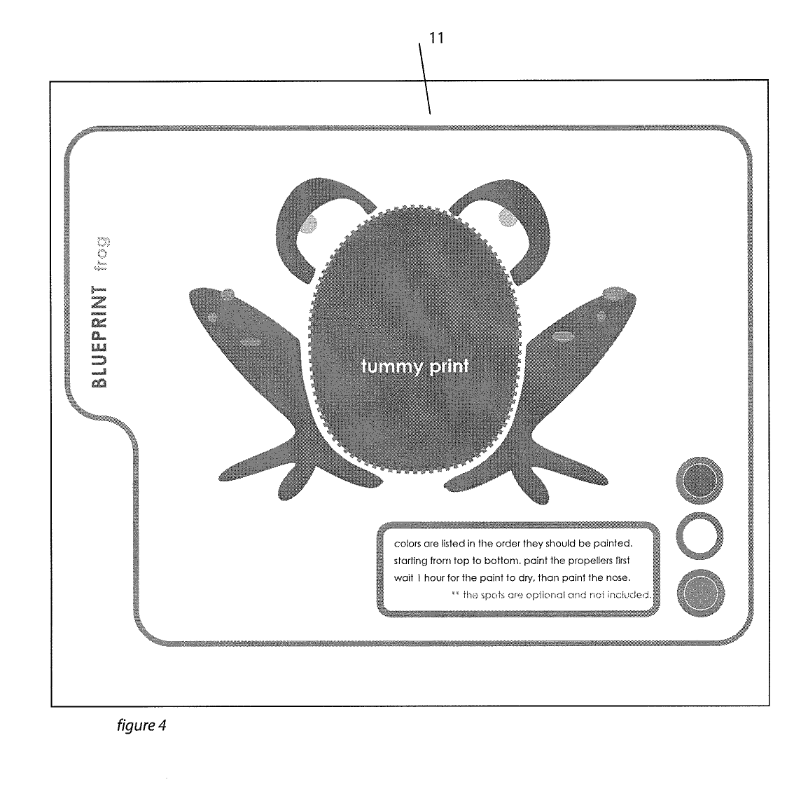

FIG. 4 generally illustrates a frog blueprint (11) used to indicate how to position at least one shape in conjunction with the contours of a body print. In conjunction is defined as, wherein at least one edge of the shape is approximately congruent to a contour of a body print.

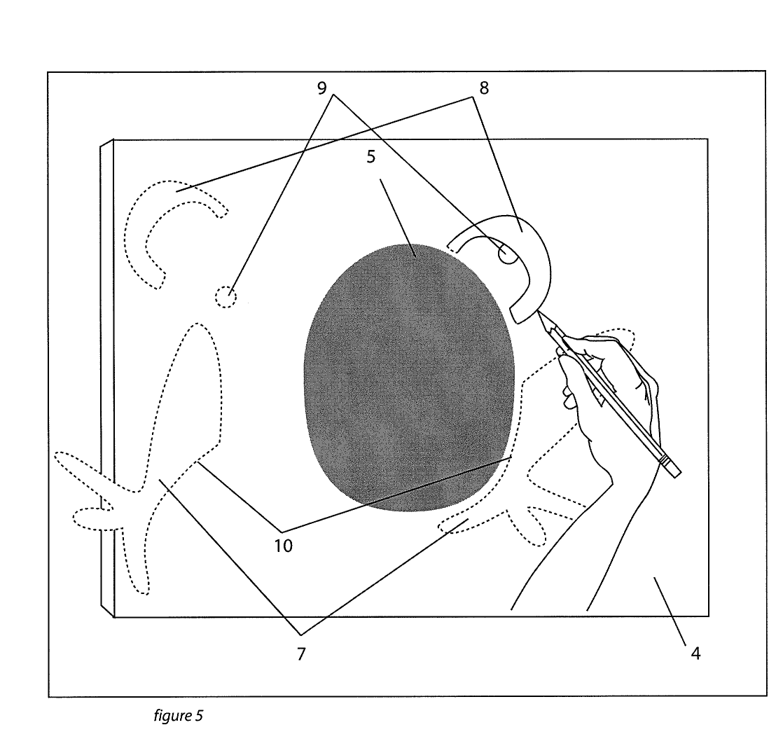

FIG. 5 generally illustrates at least one of the body shapes (7) (8) (9) positioned in conjunction with the contours of the body print (5). FIG. 5 also generally illustrates how the body shapes (7) (8) (9) should be traced onto the print-receiving surface (4). Preferably, the body shapes should be traced with a pencil, but other marking devices may also be used. The dashed lines represent the untraced body shapes, while the solid lines represent the traced body shapes. Each body shape (7)(8)(9) has two movable parts. FIG. 5 illustrates one traced frog eye shape (9) positioned under the frog eye socket shape (8). FIG. 5 illustrates one frog eye socket shape (8) currently being traced. FIG. 5 also shows one frog leg shape (7) positioned in conjunction with the rounded contour of the body print (5) using the interior edge (10) of the frog leg shape (7). The frog leg shape (7), as indicated by the dashed lines, has not yet been traced. Preferably, at least one body shape (7) (8) (9) should be traced and positioned in conjunction with the contours of the body print (5), but various modifications may be made by the user.

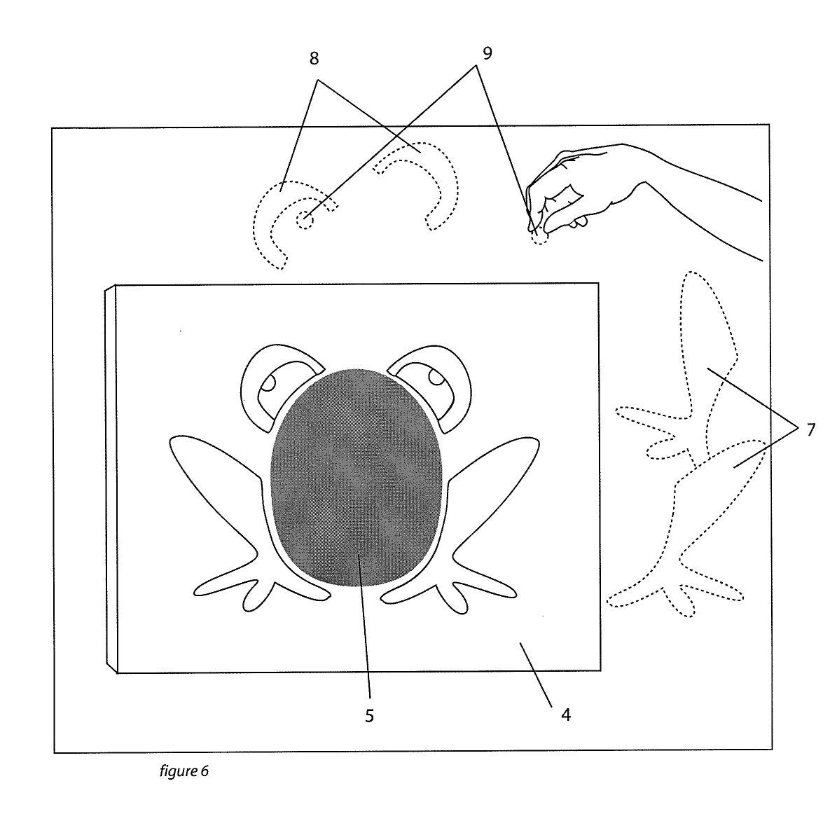

FIG. 6 generally illustrates at least one traced body shape positioned in conjunction with the contours of a body print (5) on the print-receiving surface (4) to create a recognizable design. FIG. 6 also generally shows how the body shapes (7)(8)(9) are removed after they are traced onto the print-receiving surface (4). The solid lines inside the four corners of the print-receiving surface (4), and outside of the body print (5), represent the traced body shapes. Whereas, the dashed lines outside the four corners of the print-receiving surface (4) represent the actual body shapes (7)(8)(9). FIG. 6 illustrates a good visual reference of the removal of the body shapes (7)(8)(9) after they have been traced onto the print-receiving surface (4).

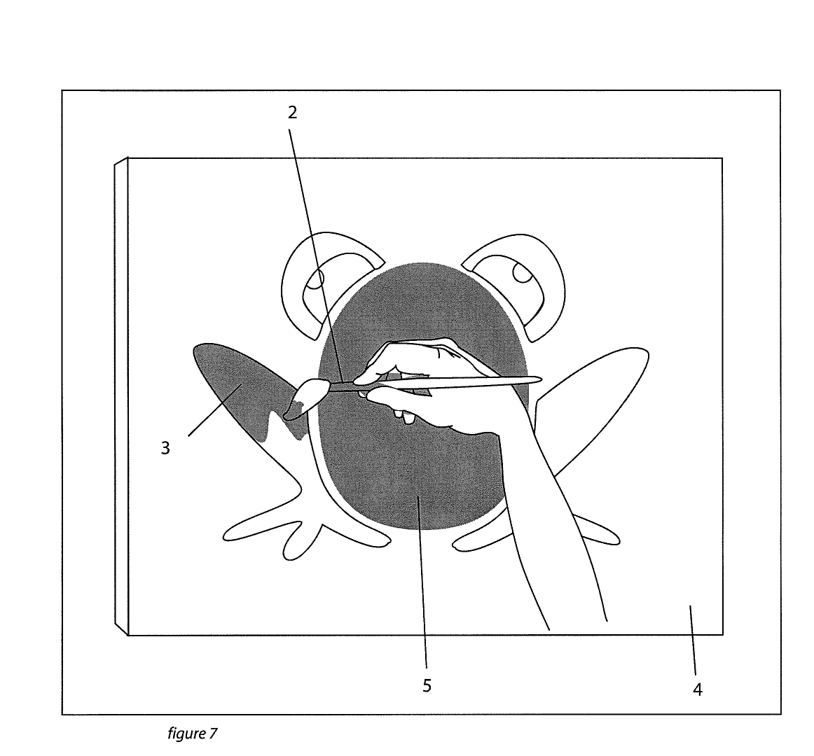

FIG. 7 generally illustrates paint (3) being applied to any area inside the traced body shapes. The paint is applied to the print-receiving surface (4) by the application device (2). The preferred application device (2) is a size 8 long handled flat brush, but other application devices may also be used, including but not limited to various sized brushes, sponges, tissues, and cotton swabs. Using an application device (2), paint (3) should be applied to the area inside the traced body shapes. The preferred paint (3) is lukascryl studio acrylic, but other paints and inks may also be used.

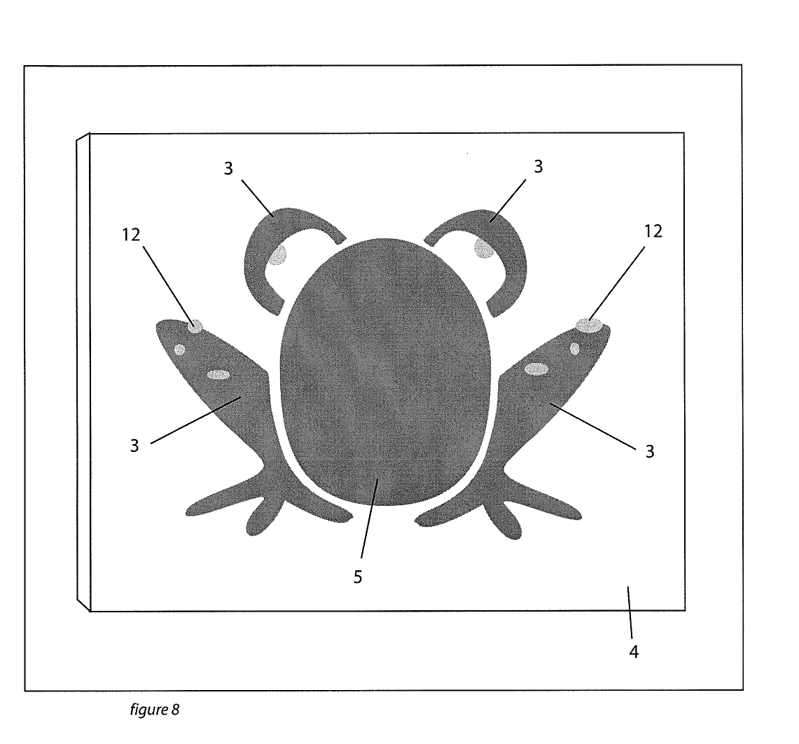

FIG. 8 generally illustrates the final artwork on the print-receiving surface (4). Preferably, the artwork will result from at least one painted (3) traced body shape positioned in conjunction with the contours of the rounded body print (5). FIG. 8 illustrates the preferred final artwork, but artistic modifications may be made. A user, for example, may attach spots (12) to different areas of the print-receiving surface to enhance the artwork.

Preferably, a set of instructions should be included in a kit. The set of instructions will give direction, as set out in FIGS. 1-8, along with recommended color schemes. The set of instructions will assist the user by providing step-by-step instructions to achieve a preferred final artwork.

While the preferred embodiment of the invention has been described above, it will be recognized and understood, by those skilled in the art, that various modifications may not be limited to the disclosed embodiment. The appended claims are intended to cover all such modifications, and equivalents thereof, that fall within the spirit and scope of the appended claims broadest interpretations.

What is claimed is:

1. A kit, comprising:
a print-receiving surface;
at least one shape, wherein at least one edge of the shape is approximately congruent to a contour of a body print;
at least one paint; and
at least one application device.

2. The kit as in claim 1, wherein a blueprint indicates how to position the shape to create a recognizable design.

3. The kit as in claim 1, wherein the print-receiving surface is a canvas.

4. The kit as in claim 1, wherein the edge of the shape is approximately congruent to a contour of a body print created by a woman's pregnant belly.

5. The kit as in claim 1, wherein the paint is acrylic.

6. The kit as in claim 1, wherein the application device is a paintbrush.

7. The kit as in claim 1, wherein the application device is a sponge.

8. The kit as in claim 1, wherein the edge of the shape is approximately congruent to a contour of a body print created by a child's hand or foot.

9. The kit as in claim 1, wherein there is a set of instructions.

10. A method for creating life prints, the method comprising:
painting the surface of a body part;
creating a body print by applying the painted body part to a paint receiving surface;
positioning at least one shape, having at least one edge approximately congruent to a contour of the body print, next to the print;
tracing the shape; and
painting any area inside the traced shape to create a recognizable design.

11. A method as in claim 10, wherein the surface is a canvas.

12. A method as in claim 10, wherein the painted body part is a woman's pregnant belly.

13. A method as in claim 10, wherein several shapes are used to create a life print depicting a frog.

14. A method as in claim 13, wherein the shapes resemble at least one frog leg, at least one frog eye socket, and at least one frog eye.

15. A method as in claim 14, wherein the frog leg shape has at least one edge approximately congruent to a contour of the body print using the interior edge of the frog leg shape.

16. A method as in claim 14, wherein the frog eye socket shape has at least one edge approximately congruent to a contour of the body print using at least one edge of the frog eye socket shape.

17. A method as in claim 15 or 16, wherein the body print is created from a woman's pregnant belly.

18. A method as in claim 14, wherein the frog eye shape is positioned under the frog eye socket shape.

19. A method as in claim 10, wherein the area inside the traced shape is painted with acrylic paint.
